(19) United States
(12) Patent Application Publication
(10) Pub. No.: US 2019/0301206 A1
(43) Pub. Date: Oct. 3, 2019

(54) Ergonomic Sliding Panel Security Shaft

(71) Applicant: Andrew Mark Hiller, Fort Collins, CO (US)

(72) Inventor: Andrew Mark Hiller, Fort Collins, CO (US)

(21) Appl. No.: 16/374,742

(22) Filed: Apr. 3, 2019

Related U.S. Application Data
(60) Provisional application No. 62/651,726, filed on Apr. 3, 2018.

(51) Int. Cl. E05B 65/08; E05C 19/00

(52) U.S. Cl. CPC E05B 65/0888; E05Y 2900/148; E05Y 2900/132; E05C 19/003

(57) ABSTRACT

A sliding panel security shaft for securing doors and windows with a locking extendable shaft and an ergonomic vertical handle that extends to approximately the height of a persons hands when standing allowing the user to install and remove the shaft from the frame of a sliding panel without bending over.

### CROSS REFERENCE TO RELATED APPLICATIONS

This application claims the benefit of U.S. Provisional Patent Application No. 62/651,726, filed on Apr. 3, 2019, also titled “Ergonomic Sliding Panel Security Shaft” which is incorporated by reference herein in its entirety for all purposes.

### BACKGROUND OF THE INVENTION

### 1. Field of the Invention

The present invention is in the technical field of door jams. More particularly, the present invention pertains to the field of door jams for sliding doors.

### 2. Description of Related Art

The use of shafts to secure a sliding door is well known around the world. It is a safe and convenient solution that provides a more secure closing of a sliding door, which by their nature often have ineffective locks. The problems associated with using sticks and bars to jam sliding doors are that the shaft has to be an exact length, and that you have to bend over to place, remove, or adjust the shaft frequently; the present invention solves both these problems.

### SUMMARY

The scope of the present invention is defined solely by the appended claims and detailed description of a preferred embodiment, and is not affected to any degree by the statements within this summary. The present disclosure generally involves an ergonomic device used to secure sliding panels that does not require the user to bend over to place, remove, or adjust the shaft the device in a sliding door jam. The device is adjustable to accommodate sliding panels of various lengths and featuring an affixed vertical handle that tacks to the panel to maintain vertical handle accessibility whether device is in place or removed.

### BRIEF DESCRIPTION OF THE DRAWINGS

Various embodiments are described herein with reference to the following Drawings. Certain aspects of the Drawings are depicted in a simplified way for reason of clarity. Not all alternatives and options are shown in the Drawings and, therefore, the Claims are not limited in scope to the content of the Drawings.

### 1. FIGURES

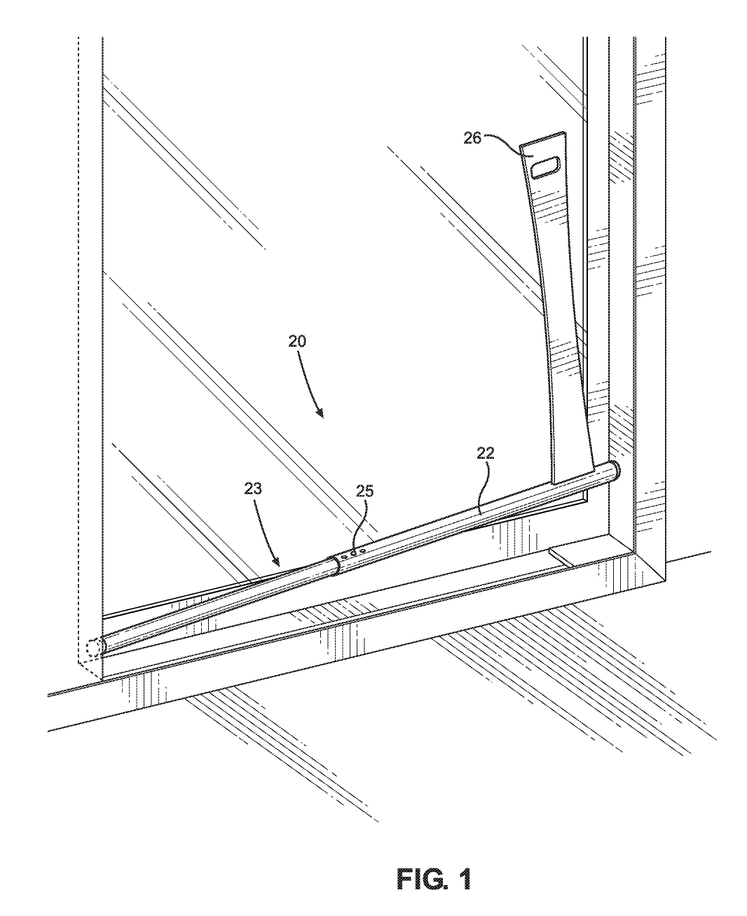

FIG. 1 illustrates a side view of a sliding panel security shaft assembly, in accordance with an embodiment of the present disclosure.

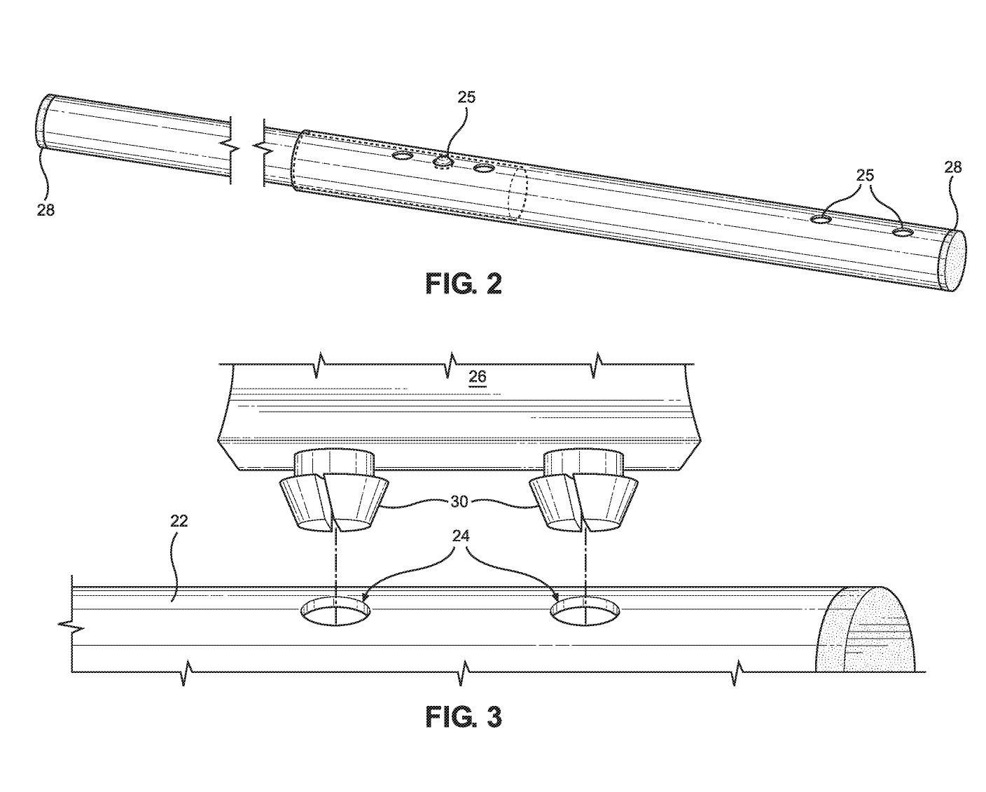

FIG. 2 illustrates an internal view of a security shaft, in accordance with an embodiment of the present disclosure.

FIG. 3 illustrates a method for attachment of a handle to a sliding panel security shaft, in accordance with an embodiment of the present disclosure.

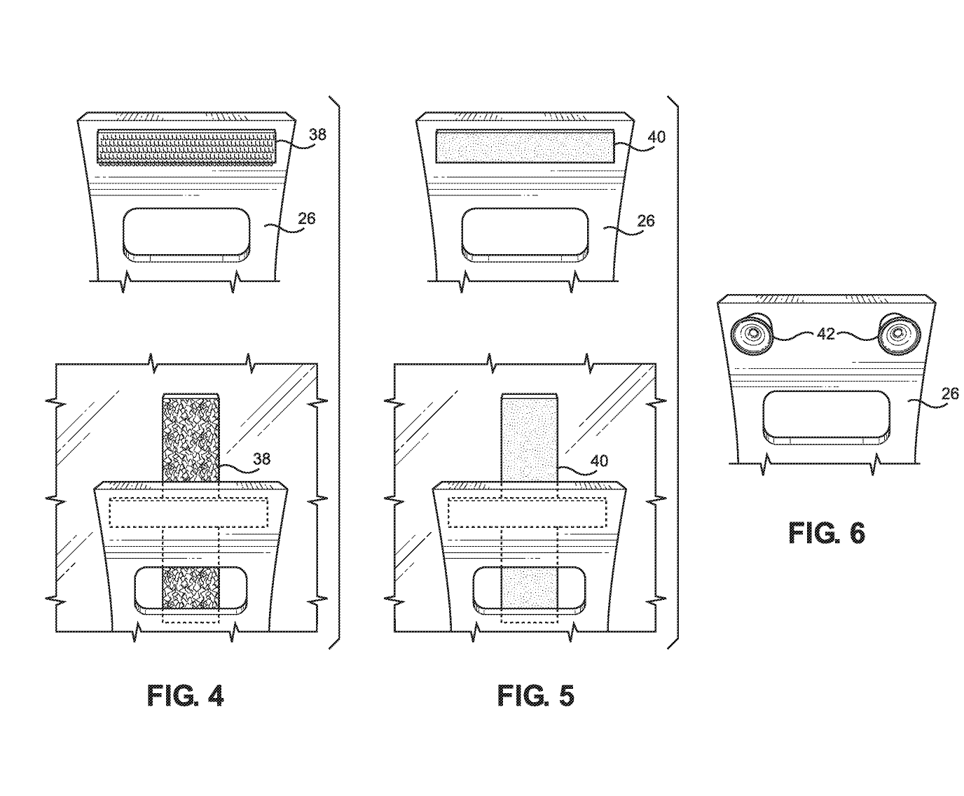

FIG. 4 illustrates a hook and loop coupling for attachment of a handle to a panel, in accordance with an embodiment of the present disclosure.

FIG. 5 illustrates a magnetic coupling for attachment of a handle to a panel, in accordance with an embodiment of the present disclosure.

FIG. 6 illustrates a suction cup coupling for attachment of a handle to a panel, in accordance with an embodiment of the present disclosure.

Corresponding reference characters indicate corresponding components throughout the several figures of the Drawings. Elements in the several figures are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiment are often not depicted in order to facilitate a less obstructed view of these various embodiments of the present disclosure.

### 2. REFERENCES

20 Sliding Panel Security Shaft
22 Security Shaft
23 Extendable Security Shaft
24 Points Of Attachment
25 Locking Mechanism
26 Handle
28 Rubber Or Non-Slip End Pieces
30 Coupling Mechanism For Attachment
32 A Mechanism For Removably Securing A Handle In An Upright Position
34 A Handle Mechanism For Attachment
36 A Panel Mechanism For Attachment
38 Hook-And-Loop (Velcro) Coupling
40 Magnetic Coupling
42 Suction Cup Coupling

### DETAILED DESCRIPTION

The following description is not to be taken in a limiting sense, but is made merely for the purpose of describing the general principles of exemplary embodiments, many additional embodiments of this invention are possible. It is understood that no limitation of the scope of the invention is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Thus, appearances of the phrases “in one embodiment,” “in an embodiment,” and similar language throughout this specification may, but do not necessarily, all refer to the same embodiment.

Further, the described features, structures, or characteristics of the present disclosure may be combined in any suitable manner in one or more embodiments. In the Detailed Description, numerous specific details are provided for a thorough understanding of embodiments of the disclosure. One skilled in the relevant art will recognize, however, that the embodiments of the present disclosure can be practiced without one or more of the specific details, or with other methods, components, materials, and so forth. In other instances, well-known structures, materials, or operations are not shown or described in detail to avoid obscuring aspects of the present disclosure. Any alterations and further modifications in the illustrated devices, and such further application of the principles of the invention as illustrated herein are contemplated as would normally occur to one skilled in the art to which the invention relates.

Unless otherwise indicated, the drawings are intended to be read (e.g., arrangement of parts, proportion, degree, etc.) together with the specification, and are to be considered a portion of the entire written description of this invention. As used in the following description, the terms “horizontal”, “vertical”, “left”, “right”, “up” and “down”, as well as adjectival and adverbial derivatives thereof (e.g., “horizontally”, “rightwardly”, “upwardly”, etc.), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate. Also, as used herein, terms such as “positioned on” or “supported on” mean positioned or supported on but not necessarily in direct contact with the surface.

The phrases “at least one,” “one or more,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. The terms “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

For the purposes of promoting an understanding of the principles of the present invention, reference will now be made to the embodiments illustrated in the drawings and specific language will be used to describe the same.

FIG. 1 illustrates a side view of a sliding panel security shaft assembly 20 (the assembly). The assembly may be comprised of several pieces. The first piece of the assembly called the security shaft 22 can be made of either a single piece of solid material or two or more pieces that connect together and may or may not be extendable along their length. The security shaft 22 is intended to be used by laying the sturdy narrow shaft within the frame along the track of a sliding panel, such as: a window, or a sliding door on a track; the security shaft thereby prevents the sliding panel from traveling on the track and opening. This method of locking a sliding panel provides more security than simply relying on the typically provided panel-latching device (which can often be easily circumvented).

In an ideal embodiment, the security shaft 22 is comprised of two or more pieces of hollow tubing, one of which slides into the other such that the combination of the two pieces of tubing creates an extendable security shaft 23. It doesn't matter if the tubing is round, square, or another geometric shape. The extendable security shaft 23, once extended to the desired length, can then be locked at that specific length with one or more locking mechanisms 25. The locking mechanism 25 may adjust to security shaft to a specific length in a number of ways, for example: one way it for it to screw lengthwise like a standard shower curtain rod, or like a paint roller extension rod; another way would be for it to fold out lengthwise; another way would be for it to extend lengthwise like the legs of a folding table, or walking cane, with tabs or pins that you can push in to allow the shaft to extend and lock; other commons methods of extending shafts in a locking fashion could also be used; for example; an internal screw twist lock, or a cam lock. The potential adjustability of the extendable security shaft 23 allows for the shaft to be locked at a variety of lengths which also allows the door to be locked either shut or open to a certain degree: for example; the door could be locked open just wide enough for fresh air, or pets, to get through but not big enough for intruders to enter when desired and then adjusted to lock a door or window completely shut when desired. The security shaft may be made of any material durable enough to accomplish its purpose.

Now looking at FIG. 2, the security shaft 22 may also have one or more points of attachment 24 for attachment of a handle 26. The one or more points of attachment 24 may include any known detachable method of attachment; such as holes for snap or screw in pegs; locking joints, or any other method of fastening that may be accomplished quickly, such as within thirty seconds and requires no tools. FIG. 3 shows another embodiment of the points of attachment wherein the security shaft 22 is attached to the handle 26 at the points of attachment 24 with one or more coupling mechanisms for attachment 30; which may be snap or screw in pegs; locking joints, or any other method of fastening know to the arts. The security shaft 22 may also have one or more rubber or non-slip end pieces 28.

Looking back at FIG. 1 again, the sliding panel security shaft assembly 20 may also comprise a handle 26. The handle 26 attaches to the security shaft 22 via the one or more attachment points 24 and one or more coupling mechanisms for attachment 30. When the security shaft 22 is placed in the track of a sliding panel with the handle 26 extending vertically then the handle 26 will remain extending vertically and will assist the user in removing the security shaft 22 by allowing the standard user to remove the security shaft 22 from the sliding panel track without bending over to place, remove, or adjust the security shaft. In other words, the handle may extend vertically to approximately the height of a user's hand while the user is standing. The handle may be made of any light and sturdy material that is suitable to its purpose -preferably metal or plastic.

The sliding panel security shaft assembly 20 may also comprise a mechanism for removably securing the handle to a panel in an upright position 32, such as: A hook-and-loop (Velcro) 38 coupling, a magnetic 40 coupling, one or more suction cups 42, a hook coupling, or any other method that may be suitable to the purpose of maintaining the handle upright and vertical on the sliding door panel (typically glass). The mechanism for removably securing the handle to a panel in an upright position 32 may have two parts that create a coupling: a handle mechanism for attachment 34 and a panel (wall, window, door, vertical plane) mechanism for attachment 36, that when combined serve to keep the shaft assembly 32 handle vertically oriented in relation to the floor which assist in the placement, movement, and adjustment of the shaft. For example, one side of a hook and loop coupling or one side of a magnetic coupling may be attached to sliding door. FIG. 4 shows a hook-and-loop (Velcro) coupling 38, FIG. 5 shows a magnetic coupling 40, and FIG. 5 shows suction cups 42 as a coupling mechanism.

Information as herein shown and described in detail is fully capable of attaining the above-described object of the present disclosure, the presently preferred embodiment of the present disclosure; and is, thus, representative of the subject matter; which is broadly contemplated by the present disclosure. The scope of the present disclosure fully encompasses other embodiments which may become obvious to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the present disclosure.

What is claimed is:

1. A sliding panel security shaft assembly, comprising:
a security shaft; and
a handle, wherein when said security shaft is placed lengthwise on the floor said handle extends vertically to approximately the height of a persons hands when standing.

2. The sliding panel security shaft assembly of claim 1, wherein said security shaft is extendable and comprises one or more locking mechanisms that lock said security shaft at different lengths of extension.

3. The sliding panel security shaft assembly of claim 2, wherein said extendable security shaft comprises two or more pieces that lock together with said one or more locking mechanisms.

4. The sliding panel security shaft assembly of claim 1, wherein said security shaft further comprises one or more points for removable attachment of said handle.

5. The sliding panel security shaft assembly of claim 1, wherein said handle comprises a mechanism for removably securing said handle in an upright vertical position.

6. The sliding panel security shaft assembly of claim 5, wherein said mechanism for removably securing said handle in an upright vertical position comprises one or more suction cups.

7. The sliding panel security shaft assembly of claim 5, wherein said mechanism for removably securing said handle in an upright vertical position comprises a handle mechanism for attachment and a panel mechanism for attachment.

8. The sliding panel security shaft assembly of claim 7, wherein said handle mechanism for attachment and said panel mechanism for attachment comprise one or more hook and loop couplings.

9. The sliding panel security shaft assembly of claim 7, wherein said handle mechanism for attachment and said panel mechanism for attachment comprise one or more magnetic couplings.

10. The sliding panel security shaft assembly of claim 1, wherein said shaft further comprises rubber or non-slip end pieces.
